(19) United States
(12) Patent Application Publication
(10) Pub. No.: US 2013/0215214 A1
(43) Pub. Date: Aug. 22, 2013

(54) SYSTEM AND METHOD FOR MANAGING AVATARSADDRESSING A REMOTE PARTICIPANT IN A VIDEO CONFERENCE

(71) Applicants: Anoop DHOPTE, Pune (IN); Amit MISHRA, Westminster, CO (US)

(72) Inventors: Anoop DHOPTE, Pune (IN); Amit MISHRA, Westminster, CO (US)

(73) Assignee: AVAYA INC., Basking Ridge, NJ (US)

(21) Appl. No.: 13/401,864

(22) Filed: Feb. 22, 2012

(51) Int. Cl. H04N 7/15

(52) U.S. Cl. 348/14.08; 348/E07.083

(57) ABSTRACT

A method and system for addressing and indicating a remote person participating in a video conference call is provided. The method and system includes a local video conference unit having a local video display presenting a remote video image. A local pointing device allows a video conference participant to address one or more remote participants in the remote video image. The user input from the local pointing device may mark, highlight, “tag” or otherwise indicate the one or more remote participants. The local conference unit may also have a detection mechanism coupled to the local video display and configured to detect the user input from the local pointing device and determine a selected image region on the remote video image containing one or more addressed or selected remote participants. The selected image region corresponds to a plurality of pixels on the remote video image.

### TECHNICAL FIELD

Embodiments of the disclosure relate generally to telecommunication systems and more specifically to a system and method for enabling video based communication.

### BACKGROUND

Video based communication systems such as video conferencing systems generally enable a participant to hear and see other participants in the conference. A video conference may include presentations of audio and video programming such as photographs, slide shows, business graphics, animations, movies, or sound recordings. Participants generally participate in a conference from physically separate locations linked via a communication network that supports the transmission of audio and visual information.

A video conferencing system captures video and audio of a conference participant using a video camera and microphone. The video conferencing system then transmits such data to video conferencing systems at various locations. When the remote video conferencing system receives the video and audio data, it then presents the video on the display device and provides the audio through a speaker. A video conferencing system may display video corresponding to each location in a different window on the display device.

### SUMMARY

Embodiments of the disclosure include a system that has a local video conference unit. Further, the local video conference unit may have a local video display presenting a remote video image. In addition, a local pointing device configured to provide user input may be part of the local conference unit. The local pointing device allows a video conference participant to address one or more remote participants in the remote video image. The user input from the local pointing device may mark, highlight, “tag” or otherwise indicate the one or more remote participants. The local conference unit may also have a detection mechanism coupled to the local video display and configured to detect the user input from the local pointing device and determine a selected image region on the remote video image containing one or more addressed or selected remote participants. The selected image region corresponds to a plurality of pixels on the remote video image.

The system may also include a remote video conference unit having a remote video processing unit. Further, the remote video processing unit provides the remote video image and identity information of the one or more remote participants to the local video processing unit over a communication network. Further, the local video processing unit may process the selected image region and determine a selected remote participant based on identity information. Alternatively, the local video processing unit may transmit the selected image region of the remote video image to the remote video processing unit. Further, the remote video processing unit may process the selected image region and determine the selected remote participant based on the identity information.

### BRIEF DESCRIPTION OF THE DRAWINGS

FIG. 1 is a block diagram of an example telecommunication system according to one embodiment;

FIGS. 2A-2C are block diagrams of example video conference units according to one embodiment;

FIG. 3 is a flow chart illustrating an example method according to one embodiment;

FIG. 4 is diagram of an example video image according to one embodiment; and

FIG. 5 is a flow chart illustrating an example method according to one embodiment.

### DETAILED DESCRIPTION

Video conference technology enables communication and collaboration between groups of people located in geographic disparate locations. One example of such communication and collaboration may be the popularity of virtual classrooms. Video conferencing technology facilitates a virtual classroom by having an instructor with a group of students who are at a local classroom communicate or collaborate with a group of students who are located at a remote classroom. That is, each location of the virtual classroom may have a video conference unit that includes a video conference display showing images of people at the other location.

In such a virtual classroom environment, the instructor may want to address a student at the remote location using such video conference technology. Thus, the instructor may point, gesture toward or otherwise indicate toward an image of the student on a video conference display using a pointing device. By pointing to the remote image, the pointing device enables the instructor to address a student at a remote location by marking, highlighting, “tagging”, or otherwise indicating a portion of the remote image containing the student. Such pointing, gestures, marking, highlighting, “tagging”, or other indications may be referred to as “user input” from the pointing device. Either the video conference unit at the local classroom or at the remote location may then determine the image of the student being addressed by the instructor based on the user input. Further, the identity of the addressed student is determined and provided to the video conference unit at the remote location which notifies the addressed student at the remote location using the audio means (e.g. announcing the name of the student across a speaker) or visual means (“tagging” or highlighting the image of the student on the display) of the video conference unit.

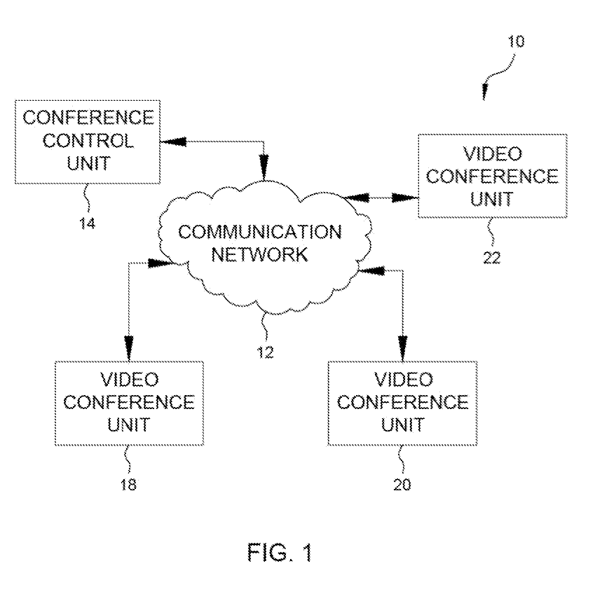

FIG. 1 illustrates a block diagram of an example video conference telecommunication system 10 according to one embodiment. The telecommunication system 10 includes a communication network 12, a conference control unit 14 and video conference units 18, 20, and 22. Further, the video conference units 18, 20, and 22 may be present at different locations. Each video conference unit 18, 20, and 22 may be accessed by one or more video conference participants.

The communication network 12 provides communication between components such as the conference control unit 14 and the video conference units 18, 20, and 22 at different locations. The communication network 12 may include local area networks, wide area networks, wireless networks, and combinations thereof including gateways and routers that include the telephone networks and/or the Internet. The communication network 12 may include conventional hardware at each location, and may further include software providing data transfer among processes and storage devices located anywhere in the telecommunication system 10.

Participants may use the conference control unit 14 for making, revising and canceling reservations for video conferences. The conference control unit 14 can also be configured for keeping records of video conferences. The conference control unit 14 may provide a data entry/edit interface for managing descriptions of participants including data that may be needed for a presentation during a conference.

The video conference units 18, 20, and 22 allow participants to participate in a video conference by displaying video images and providing audio of participants at different locations, as well as by capturing audio and visual images of local participants at a local office. Each video conference unit includes equipment that enables a participant to participate in a video conference. For example, the video conference units 18, 20, and 22 may each include a camera, a video display, a microphone, and a speaker.

In one embodiment, the telecommunication system 10 may function as a virtual classroom. In such an embodiment, the first video conference unit 18 may be designated as a local video conference unit 18 that may be accessed by the instructor of the virtual class at a local classroom. The other video conference units 20 and 22 may be designated as remote conference video units 20 and 22 that may be accessed by students of the virtual class participating at remote classrooms or locations.

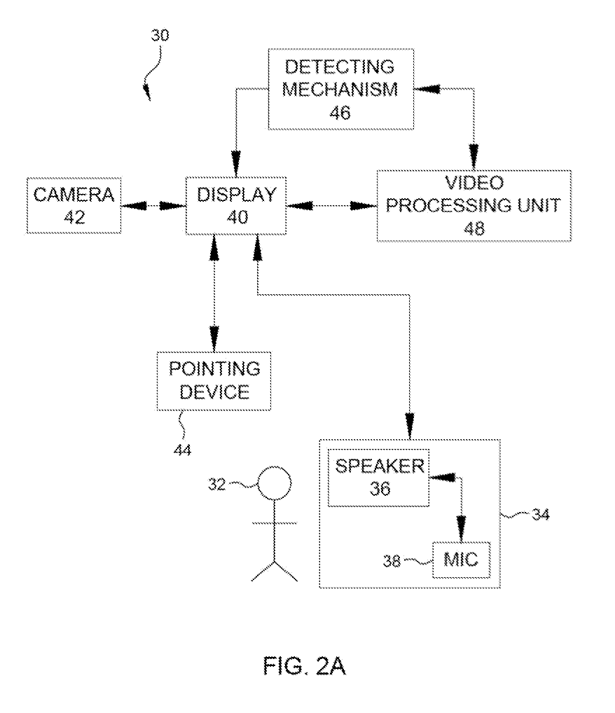

FIG. 2A is a block diagram of an example embodiment of a video conference unit 30, according to one embodiment. The video conference unit 30 may include an audio transceiver 34, a video display 40, a camera 42, a pointing device 44, detection mechanism 46, and video processing unit 48. In one embodiment, the video conference unit 30 may be accessed by a video conference participant 32, and allows the participant 32 to communicate both audibly and visually with participants at remote locations.

The audio transceiver 34 is configured to provide audio output through a speaker 36 and receive audio input through a microphone 38. In one embodiment, the audio transceiver 34 may include a speaker phone having common telephony functionality. In another embodiment, the audio transceiver 34 may include the speaker 36 and the microphone 38. The audio transceiver 34 may be any device capable of translating acoustical signals into electrical signals and vice versa.

In one embodiment, the camera 42 is configured to capture video images of the participants and their surrounding environment. The camera 42 may include an optical lens system in combination with an image sensor, such as a charge coupled device (CCD). The camera 42 may be provided as part of a video telephone or computer peripheral.

The display 40 may include any device capable of receiving video signals and displaying a corresponding image. Accordingly, the display 40 may have a cathode ray tube or liquid crystal display. The display 40 may be provided as part of a general purpose computer, video telephone, or monitor.

In one embodiment, the pointing device 44 enables a local participant to point to an image of a remote participant shown on the display 40. Such an image may be designated as a remote video image. Examples of the pointing device 44 may include laser pointers, LED pointers, infrared pointers/remote controls, and the like. By pointing to the remote video image, the pointing device 44 enables a local participant to address a remote participant at a remote location by marking, highlighting, “tagging”, or otherwise indicating a portion of the remote video image containing the remote participant. Such pointing, gestures, marking, highlighting, “tagging”, or other indications may be referred to as “user input” from the pointing device.

In one embodiment, the addressed remote participant may be marked by pointing the pointing device 44 at the image of the addressed remote participant's face for a prolonged period of time. Alternatively, the addressed remote participant may be marked by using the pointing device 44 to encircle or box the remote participant's face on the image. The remote participant can be marked in other ways, such as by selecting the remote participant with a cursor and mouse click, by multiple flashes from the pointing device 44, and the like. It should be understood that various input devices such as mice, keyboards, track pads, laser pointers, styluses, etc. or a combination thereof may be considered as a pointing device 44 to enable a local participant to provide user input directed toward the remote video image.

The detection mechanism 46 is coupled to the display unit 40, and is configured to detect the user input provided by the pointing device 44. In one embodiment, the detection mechanism 46 identifies the portion of the remote video image marked by the pointing device 44. The marked portion includes several pixels in a two-dimensional range, and may be referred to as the selected image region.

The video processing unit 48 is configured to perform video conferencing functions as well as image processing. The video processing unit 48 may include a personal computer implementing video conferencing software applications in connection with a standard operating system. The video processing unit 48 is configured to receive the remote video image and information associated with the image from the remote location. The video processing unit 48 also presents the remote video image on the display 40. In one embodiment, the information associated with the remote video image may be identification information such as the name or job title of each of the remote participants displayed in the remote video image. Such information associated with the remote video image may be used in any subsequent remote video image processing.

In one embodiment, the pointing device 44 may be a laser pointing device that emits red laser light such that the detection mechanism 46 and/or the video processing unit 48 may determine a selected image region or range of pixels on the remote video image illuminated by the laser pointing device 44. The video processing unit 48 may process the range of pixels of the remote video image to determine whether a remote participant is being indicated by the laser pointing device 44. The image processing takes into account background light in determining the selected image region and the remote participant that have been indicated by the red laser pointing device.

In another embodiment the detection mechanism 46 may include detection cameras that can be pointed towards the display. When a laser pointing device 44 illuminates a portion on the display, detection cameras can capture images on the display and pass them to the video processing unit 48 for image processing to determine the selected image region.

In another embodiment, the detection mechanism 46, may include photosensors coupled to the local display. Photosensors are able to detect the laser from the laser pointing device 44 and determine the selected image region indicated by the laser pointing device 44. The illuminated areas are captured and passed to the local video processing unit 48 to determine whether a remote participant is within the selected image region.

In an additional embodiment, the detection mechanism 46 may be a touchscreen coupled to the display 40. The pointing device 44 may be a stylus or simply the finger of the user of the system. Such a touchscreen can detect a range of pixels indicated by the pointing device 44 that can be designated as the selected image region.

In an alternative embodiment, detection mechanism 46 may include facial recognition and tagging features as used in social media websites and digital camera technology. A pointing device 44 may be used to indicate a selected image region of the remote video image presented on the display 40 containing a remote participant. Further, the facial recognition and “tagging” feature provides a “tag box” around the face of the remote participant and is shown on the remote video image. The “tag box” can be designated as the selected image region for further processing. The facial recognition and “tagging” features can be used to identify a person in a digital photograph as well as to indicate different people in a captured or soon-to-be captured digital video image.

Referring to FIG. 2B, video conference units 30a and 30b are shown coupled by a communication network 100. Video conference unit 30a is designated as a local conference unit and includes local camera 42a, local display 40a, local detection mechanism 46a, local pointing device 44a, and local video processing unit 48a. Local video conference unit 30a also includes local microphone 38a and local speaker 36a in a local audio transceiver 34a.

Video conference unit 30b is designated as a remote conference unit and includes remote camera 42b, remote display 40b, remote detection mechanism 46b, remote pointing device 44b, and remote video processing unit 48b. Remote video conference unit 30b includes remote speaker 36b and remote microphone 38b in a remote audio transceiver 34b. The components included in FIG. 2B function similarly to the corresponding components shown in FIG. 2A.

In an embodiment, local video conference unit 30a and remote video conference unit 30b reside in different locations and may be used to create a virtual classroom. The instructor of the virtual class may be at a local classroom and have access to the local video conference unit 30a. Further, the instructor may also have local students at his/her location. Alternatively, remote students may be at a remote classroom or location that is geographically separate from the instructor and have access to the remote video conference unit 30b.

A local camera 42a may capture local video images in real-time of the instructor and local students. The local video images are passed to the local display 40a and presented for viewing to the instructor and local students. This allows for local students who only have a partial view of the instructor but a full or unobstructed view of the local display 40a to view the instructor. Further, the local video images are transmitted from the local display 40a to the local video processing unit 48a.

In other embodiments the local camera 42a directly transmits the captured local video images to the local video processing unit 48a. The local video processing unit 48a transfers/transmits the local video images to a remote video processing unit 48b over the communication network 100. The remote video processing unit 48b transmits the local video images to the remote display 40b where they are presented for viewing to the remote students.

In another embodiment, a remote camera 42b may capture remote video images in real-time of the remote students at the remote location. Such remote video images are transmitted to the remote display 40b to be presented for viewing to the remote students. The remote video images may be presented side-by-side with the local video images received from the local video processing unit 48a via the communication network 100 and remote video processing unit 48b on remote display 40b. As will be discussed in further detail below, the presentation of the remote video images on the remote display 40b allows the remote students to view instructor gestures toward the remote students so as to respond to an instructor query.

The remote video images are transmitted from the remote display 40b to the remote video processing unit 48b. In other embodiments the remote camera 42b may directly transmit the captured remote video images to the remote video processing unit 48b. The remote video processing unit 48b may then transfer/transmit the remote video images to the local video processing unit 48a over the communication network 100. Further, local video processing unit 48a may transmit the remote video image to the local display 40a to be presented for viewing to the instructor and the local students. The remote video images may be presented side-by-side with the local video images on local display 40a.

At the start of any virtual class the remote video processing unit 48b, through a user interface, may receive identification information for each remote student. In one embodiment, a remote student may use a remote pointing device 44b to point to the remote video image presented on remote display 40b. Referring to FIG. 2C, eight remote students may be present at the remote location. The remote camera 42b captures a remote video image 106 of the eight remote students at the remote location. The remote camera 42b may then send the remote video image 106 to the remote video display 40b to be viewed by the remote students. A remote student 4 may use the remote pointing device 44b to mark, “tag,” or otherwise indicate his facial image on the remote video image.

The remote video processing unit 48b may have facial recognition technology that allows the remote student 4 to “tag” himself with a “tag box” as used in social media websites and in digital camera technology. Further, the “tag box” may be designated as a selected image region. The “tagging” feature functions by having the remote student 4 using the remote pointing device such as a mouse, stylus, laser pointer, etc. 44b to mark, highlight, point, or otherwise indicate a portion of the remote video image 106 substantially containing his face. The “tagging” feature can be provided by the remote video processing unit 48b and/or can be part of the detection mechanism 46b. Such a “tagging” feature functions in conjunction with the remote video display 40b to provide a “tag box” around the face of student 4 on the remote video image. At such instance, the remote video processing unit 48b may prompt remote student 4 to enter identification information that may include his name, job title or any other information associated with his identity. The identification information may be entered using various user input devices that include, but are not limited to, mouse, keyboard, touch screen, voice recognition, etc. Once the identification information is entered, the identification information is transmitted to the remote video processing unit 48b to be stored and associated with the facial image tagged by remote student 4.

The remote video image 106 and the associated identification image of the remote students 1-8 may be transmitted to the local video processing unit 48a. The local video processing unit 48a may store the identification information associated with the remote video image. The local video processing unit 48a may transfer a copy of the remote video image 106 to local display 40a to be viewed by the instructor of the virtual class as well as the local students.

In a further embodiment, the instructor may hear a question from more than one remote student at the remote location. The instructor may point toward or otherwise indicate remote student 4 using the local pointing device 44a so that the instructor can request remote student 4 to repeat his question. Thus, the local pointing device 44a may be an input device such as a laser pointer, mouse, stylus, or some other input device known in the art. The instructor via the local pointing device 44a may address remote student 4 by indicating a selected image region of the remote video image 106 on local display 40a that contains the face of remote student 4. The local video processing unit 48a may provide a facial recognition feature as part of the local detection mechanism 46a that allows the local display 40a to “tag” the face of remote student 4 with a box 104. The “tagged” remote video image at the local display 40a may be transmitted to the local video processing unit 48a for further processing.

Other embodiments may include the local video processing unit 48a using image processing techniques, to determine the identity of “tagged” remote student 4 based on the previously received identity information of the remote students. Further, the local video processing unit 48a may transmit a subset of the identification information such as the name or job title of remote student 4 to the remote video processing unit 48b. The remote video processing unit 48b may convert the text related to the received identification information to speech using speech technology. Further, the remote video processing unit 48b may relay the speech containing the name to remote audio transceiver 34b to be played through the speaker 36b at the remote location.

In an alternative embodiment, the remote video processing unit 48b may process the name of remote student 4 with the remote video image 106 and associate the name to the face of remote student 104 on the remote video image 106 using image processing techniques. Thus, in an example embodiment the remote video processing unit 48b may display a tag box 104 on the remote video image 106 presented on the remote video display 40b to be viewed by the remote students 1-8 so that remote student 4 would understand that the instructor is addressing him and requesting remote student 4 to repeat his question.

In an additional embodiment the local video processing unit 48a transmits the remote video image 106 with the “tag box” as determined by the facial recognition feature on the local video processing unit 48a. The remote video processing unit 48a receives the “tagged” remote video image and presents the “tagged” remote video image on the remote display 40b. By viewing the “tagged” remote video image, remote student 4 would understand that the instructor is addressing him.

The facial recognition and “tagging” features described above may be incorporated in either the local detection mechanism 46a or remote detection mechanism 46b. The “tag” box or any marked, highlighted, or otherwise indicated portion of the remote video image 106 by a pointing device 44a and 44b may be designated as a selected image region and may correspond to a two-dimensional range of pixels.

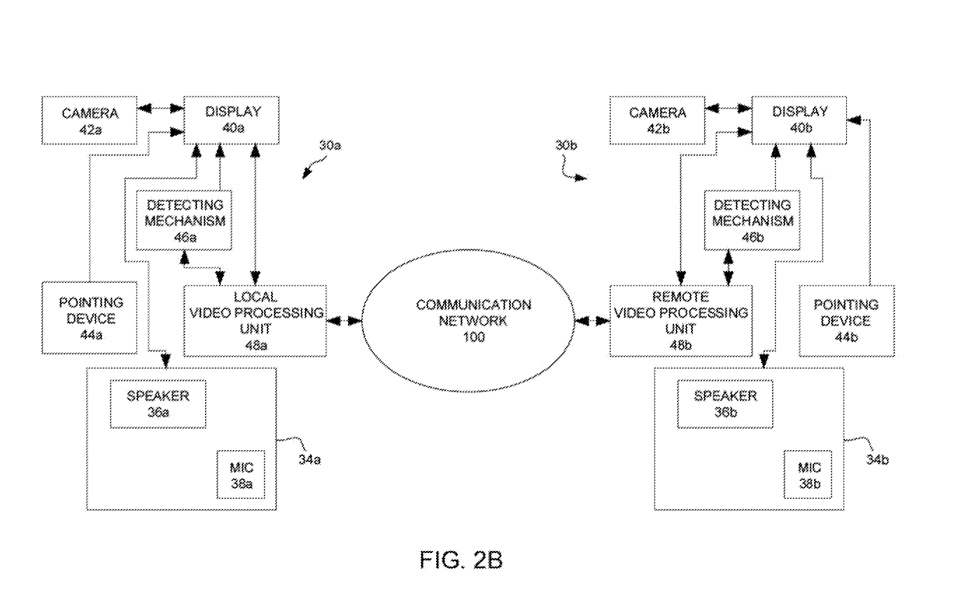

FIG. 3 is a flow chart illustrating an example method for effective communication between participants of a video conference, according to one embodiment. The method is described with reference to a video conference occurring between two participants at two locations as shown in FIGS. 2A-2C. However, in another embodiment the example method may be applied to video conferences occurring at multiple locations as well. For ease of example illustration, the video conference units in the two locations are referred to as a local video conference unit and a remote video conference unit.

At step 52, a remote video image of remote participants is received by the local video conference unit over a communication network. In one embodiment, the identification information of each remote participant and the location of each remote participant in the remote video image are also received by the local video conference unit. Further, the remote video image is presented on a local video display of the local video conference unit.

At step 54, user input is provided by using a local pointing device. For example, a participant may use the local pointing device to address a remote participant by marking a portion of the remote video image and designated such portion as the selected image region. In one embodiment, the user input includes using the local pointing device to encircle an area or placing a “tag box” on the image containing an image of a particular participant.

At step 56, a two-dimensional range of pixels corresponding to the selected image region is identified. The selected image region is captured by the detection mechanism and the pixels corresponding to the selected image region are identified by the local video processing unit. In one embodiment, at least four pixels corresponding to the selected image region are identified.

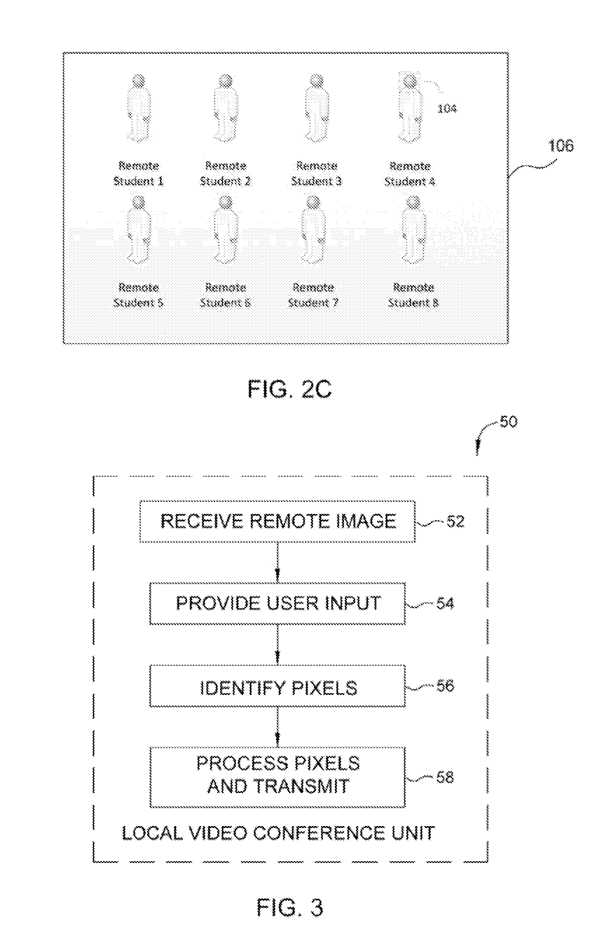

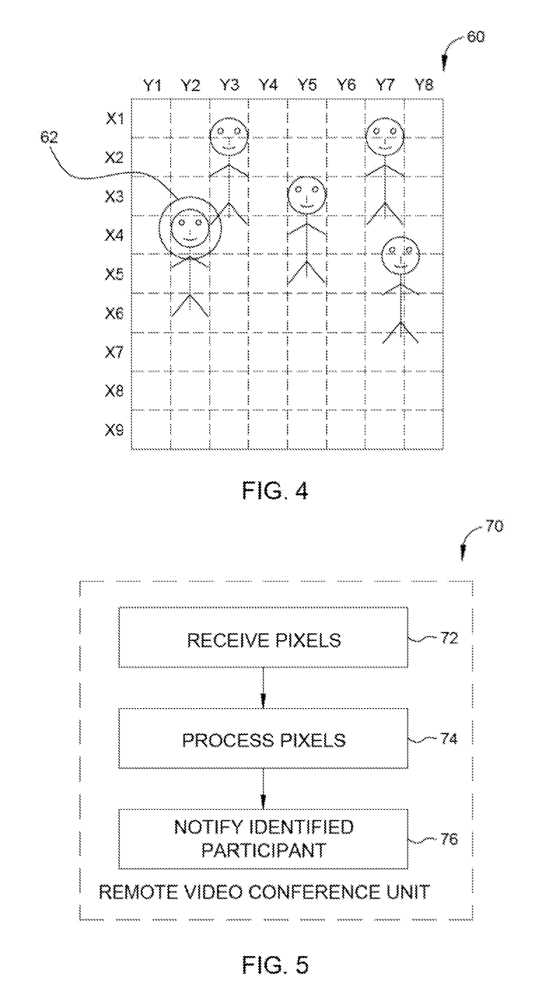

At step 58, the pixels corresponding to the selected image region may be processed and transmitted to the remote video conference unit. The manner in which the pixels are identified is shown in FIG. 4. Remote video image 60 includes several pixels, each pixel identified by its respective row and column. The local pointing device marks a portion 62 of the remote video image which can be designated as a selected image region. The detection mechanism identifies the portion of the image and the video processing unit identifies the pixels contained in the selected image region. In the illustrated image, selected image region 62 includes a two-dimensional range of pixels (X3, Y2), (X4, Y1), (X4, Y2) and (X4, Y3). This range of pixels are either processed by the local video processing unit or transmitted to the remote video processing unit for image processing. The manner in which the a video processing unit processes the pixels to accurately identify a participant being addressed is described in further detail with reference to the example method 70 described in FIG. 5.

At step 72, the pixels (X3, Y2), (X4, Y1), (X4, Y2) and (X4, Y3) corresponding to selected image region and indicating the remote participants is received by the remote video processing unit. In one embodiment, the pixels may be received over a communication network such as the Internet, local area network, and the like. At step 74, the pixels are processed by remote video processing unit to identify the addressed participant. In one embodiment, the pixels are compared with the original remote video image to accurately determine the addressed participant. At step 76, the identified participant is notified that the he is being addressed by the remote video conference unit through audio means of a speaker or visual means such as “tag box” around the image of identified participant on the video conference display.

The above described features provide the capability to address desired participants in a video conference. Aspects of the present disclosure can be implemented using input devices readily available in standard video conference units.

Although the steps, operations, or computations may be presented in a specific order, the order may be changed in particular embodiments. Other orderings of the steps are possible, depending on the particular implementation. In some particular embodiments, multiple steps shown as sequential in this specification may be performed at the same time.

Although the description has been described with respect to particular embodiments thereof, these particular embodiments are merely illustrative, and not restrictive. Concepts illustrated in the examples may be applied to other examples and embodiments.

Note that the functional blocks, methods, devices, and systems described in the present disclosure may be integrated or divided into different combinations of systems, devices, and functional blocks as would be known to those skilled in the art.

What is claimed is:

1. A system comprising:
a local video conference unit including:
a local video display presenting a remote video image;
a detection mechanism coupled to the local video display and configured to detect the user input, wherein the user input indicates one or more remote participants in a selected image region on the remote video image.

2. The system of claim 1, wherein the selected image region corresponds to a plurality of pixels on the remote video image.

3. The system of claim 1, further comprising a remote video conference unit having a remote video processing unit that provides the remote video image and an identity information of the one or more remote participants to the local video processing unit.

4. The system of claim 3, wherein the local video processing unit processes the selected image region and determines a selected remote participant based on the identity information of the one or more remote participants.

5. The system of claim 1, wherein the local video processing unit transmits the selected image region of the remote video image to the remote video processing unit, wherein the remote video processing unit processes the selected image region and determines a selected remote participant based on an identity information of the one or more remote participants.

6. The system of claim 1, wherein the detection mechanism is selected from the group of detection cameras, detection photosensors, touchscreen, facial recognition and tagging features, or a combination thereof.

7. The system of claim 3, wherein the remote video conference unit receives the identity information of the one or more remote participants through remote user input from a remote pointing device that is selected from the group consisting of a mouse, keyboard, touch screen, voice recognition, facial recognition and tagging features, or a combination thereof.

8. A method comprising:
receiving a remote video image at a local video processing unit;
causing a local display to present the remote video image by the local video processing unit;
detecting the user input on the remote video image using a detection mechanism coupled to the local video display wherein the user input indicates one or more remote participants in the remote video image; and
determining a selected image region containing the one or more remote participants on the remote video image based on the user input.

9. The method of claim 8, wherein the selected image region corresponds to a plurality of pixels on the remote video image.

10. The method of claim 8, further comprising providing the remote video image and an identity information of the one or more remote participants to the local video processing unit by a remote video conference unit having a remote video processing unit.

11. The method of claim 8, further comprising processing the selected image region by the local video processing unit to determine a selected remote participant based on an identity information of the one or more remote participants.

12. The method of claim 8, further comprising:
transmitting the selected image region of the remote video image to the remote video processing unit;
processing the selected image region by the remote video processing unit; and
determining a selected remote participant based on an identity information of the one or more remote participants.

13. The method of claim 8, wherein the detection mechanism is selected from the group of detection cameras, detection photosensors, touchscreen, facial recognition and tagging features, or a combination thereof.

14. The method of claim 8, wherein the remote video conference unit receives an identity information of the one or more remote participants through remote user input from a remote pointing device that is selected from the group consisting of mouse, keyboard, touch screen, voice recognition, facial recognition and tagging features, or a combination thereof

15. A system comprising:
a local video conference unit including:
a local video display presenting a remote video image;
a detection mechanism coupled to the local video display and configured to detect the user input, wherein the user input indicates one or more remote participants in a selected image region on the remote video image;
a remote video conference unit coupled to the local video conference unit, the remote video conference unit including:
a remote camera that captures the remote video image;
a remote display that receives the remote video image from the remote camera and presents the remote video image; and
a remote video processing unit that receives the remote video image from a remote camera and transmits the remote video image to the local video processing unit.

16. The system of claim 15, wherein the selected image region corresponds to a plurality of pixels on the remote video image.

17. The system of claim 15, wherein remote video processing unit receives an identity information of the one or more remote participants from a remote pointing device and the remote video processing unit transmits the identity information of the one or more remote participants to the local video processing unit,
wherein the remote pointing device is selected from the group consisting of mouse, keyboard, touch screen, voice recognition, facial recognition and tagging features, or a combination thereof.

18. The system of claim 15, wherein the local video processing unit processes the selected image region and determines a selected remote participant based on an identity information of the one or more remote participants.

19. The system of claim 15, wherein the local video processing unit transmits the selected image region of the remote video image to the remote video processing unit, the remote video processing unit processes the selected image region and determines a selected remote participant based on an identity information of the one or more remote participants.

20. The system of claim 15, wherein the detection mechanism is selected from the group of detection cameras, detection photosensors, touchscreen, facial recognition and tagging features, or a combination thereof.
